(19) United States
(12) Patent Application Publication
(10) Pub. No.: US 2026/0202537 A1
(43) Pub. Date: Jul. 16, 2026

(54) DIGITAL CONICAL SCANNING

(71) Applicant: KRATOS INTEGRAL HOLDINGS, LLC, San Diego, CA (US)

(72) Inventor: Jonathan Baker, San Diego, CA (US)

(21) Appl. No.: 19/561,199

(22) Filed: Mar. 9, 2026

Related U.S. Application Data
(63) Continuation of application No. PCT/US2024/046432, filed on Sep. 12, 2024.

(51) Int. Cl. G01S 13/72; H01Q 13/02

(52) U.S. Cl. CPC G01S 13/72; H01Q 13/02

(57) ABSTRACT

Conical scanning has advantages over other target-tracking techniques in tracking a satellite in low Earth orbit. However, conventional conical scanning requires mechanical movement, which reduces longevity and requires precise manufacturing tolerances. Disclosed embodiments provide non-mechanical conical scanning. In particular, conductive strips of semiconducting material are formed along a radially inner surface of a feed horn from the proximate end to the distal end, with insulating gaps between adjacent conductive strips. A controller, in a plurality of rotational steps, selects a subset of conductive strips, and controls a switch matrix to connect the subset to a first voltage source, while connecting all of the other conductive strips to a second voltage source, to change an electrical property in the subset relative to the other conductive strips. This effects a rotation of the center of the antenna beam around the mechanical center of the antenna.

### CROSS-REFERENCE TO RELATED APPLICATIONS

This application claims priority to U.S. Provisional Patent App. No. 63/538,475, filed on Sep. 14, 2023 and International Patent Application No. PCT/US2024/046432 filed on Sep. 12, 2024, which are hereby incorporated herein by reference as if set forth in full.

### BACKGROUND

### Field of the Invention

The embodiments described herein are generally directed to target tracking, and, more particularly, to non-mechanical (i.e., digital) conical scanning for tracking satellites by a ground station or for other tracking applications.

### Description of the Related Art

Conical scanning (conscan) is a type of target-tracking technique that was introduced in early Radar Detection and Ranging (radar) to improve target-pointing accuracy. It has also been used in gun-laying applications, and has been adapted for use in line-of-site tracking applications, as well as for satellite tracking.

Generally, conical scanning comprises offsetting the center of the radiation pattern of an antenna beam, from the mechanical center, by a small amount, and rotating the antenna beam to give feedback on the target's location. FIG. 1 illustrates four discrete rotations of the antenna beam and the corresponding amplitudes, according to an example. Essentially, conical scanning modulates the amplitude of the received signal, and uses that amplitude information, together with the rotational angles (i.e., phase), to produce a position vector on the target. When the antenna beam is on target, the amplitude (i.e., signal strength) will be constant, regardless of the rotational angle.

There are three main methods for implementing the circular rotation of the beam in conical scanning: rotating the antenna reflector; rotating an offset sub-reflector of the antenna; or rotating an offset feed of the antenna. All of these methods require mechanical rotation, typically in the 5 -25 Hertz (Hz) range. Rotation of the antenna reflector is practically limited by the size of the antenna. While rotating a one-meter antenna reflector may be possible, rotating a ten-meter antenna reflector is mechanically challenging. Thus, rotation of the offset sub-reflector or the offset feed are more common approaches. However, any mechanical approach is associated with wear and tear that impacts the life span of the associated components. A mechanical approach also requires high-precision manufacturing with low tolerances and high costs.

Many low-Earth-orbit (LEO) applications require open-loop tracking, such as two-line-element (TLE) or table tracking, because it is inexpensive with acceptable performance for low-frequency, wide-beam-width antenna systems, such as L-band (i.e., 1-2 gigahertz (GHz)), S-band (i.e., 2-4 GHz), and potentially X-band (i.e., approximately 7.0-11.2 GHz) systems. Open-loop tracking can be used for all LEO tracking applications, to initially position the antenna before engaging closed-loop tracking.

For higher frequency antenna systems, in which the beam-widths are narrow, such as Kₐ-band (i.e., 26.4-40 GHz) or Q/V band (i.e., 33-75 GHz) systems, more accuracy is required. While closed-loop monopulse tracking, which uses additional encoding of the radio signal to provide directional information, could be used, it would be expensive. In addition, monopulse tracking, in small-sized or medium-sized antennas used for LEO applications, can suffer from a reduced carrier-to-noise ratio (C/N) at low angles of elevation. Assuming a carrier-to-noise ratio of 20 decibels (dB), acquiring an LEO satellite at a low angle of elevation could be a significant issue. In particular, the carrier-to-noise ratio for the difference channel can be severely degraded, thereby nullifying the difference channel. This leads to a dead-band in the angles of elevation, in which a pointing error vector cannot be accurately resolved. Moreover, 20 dB is an assumed value that may be optimistic for LEO scenarios. Suffice it to say, a low carrier-to-noise ratio may prevent initial acquisition of an LEO satellite.

Step tracking is another common closed-loop radio frequency (RF) approach for tracking a target. In step tracking, the antenna beam is moved slightly off the programmed position in a predetermined pattern about the anticipated target position, while obtaining amplitude measurements of the target from the receiver. However, at millimeter wave frequencies, the received signal amplitude or strength is susceptible to rapid instantaneous fluctuations due to propagation impairments, such as gaseous absorption, cloud and rain attenuation, and tropospheric scintillation, which can be significant at low angles of elevation. To obtain an accurate measure of amplitude at such frequencies, the received RF signal must be integrated over some time period, which leads to latencies associated with obtaining the accurate measured signal amplitudes at each position. These latencies can be on the order of seconds, which is significant when tracking an LEO satellite.

In terms of accuracy, conical scanning is comparable to monopulse, and results in a simpler receive/tracking system. In addition, conical scanning is good for tracking dynamic (i.e., LEO) objects, even at low angles of elevation. Conical scanning is also able to scan relatively wide areas for quick acquisition of a target, and then help steer the antenna onto the target. The conscan fine-pointing method is extremely dynamic and produces pointing errors that allow minimal degradation in the amplitude of the downlink signal, even for medium-sized apertures.

However, conical scanning can introduce a small reduction in transmitted power to the satellite or received power (and antenna gain-to-noise temperature (G/T)) from the satellite, due to the small offset in the beam center. Both of the transmit and receive signals will experience small amplitude variations due to the rotation of the beam. Conical scanning is also susceptible to noise introduced by amplitude interference, for example, due to propagation impairments. Although, this can be mitigated by increasing the rotational speed, such that these interferences can be quickly averaged out. However, because conical scanning relies on mechanical components, the components are susceptible to wear and tear and require precise manufacturing to mitigate the heavy duty cycle, especially at high rotational speeds. A mechanical approach also makes it difficult to provide variable scan frequencies, which may be necessary for targets whose positions change rapidly.

### SUMMARY

Accordingly, embodiments are disclosed for non-mechanical conical scanning.

In an embodiment, a feed horn for an antenna comprises: a conical section having a diameter that increases from a proximate end to a distal end along a longitudinal axis of the conical section; a plurality of conductive strips on a radially inner surface of the conical section, wherein each of the plurality of conductive strips extends from the proximate end to the distal end of the conical section; and a plurality of insulating gaps between each adjacent pair of the plurality of conductive strips. Each of the plurality of conductive strips may be formed from a material that has low impedance when a first voltage is applied to the conductive strip and has high impedance when a second voltage is applied to the conductive strip. Each of the plurality of conductive strips may comprise a semiconducting or semi-metal material. Each of the plurality of conductive strips may comprise graphene. A number of the plurality of conductive strips may be at least four. The feed horn may further comprise a cylindrical section extending along the longitudinal axis from the proximate end of the conical section, wherein each of the plurality of conductive strips extends from a proximate end of the cylindrical section to the distal end of the conical section.

In an embodiment, an antenna comprises: the feed horn; a switch matrix that comprises a plurality of switches configured to independently connect each of the plurality of conductive strips in the feed horn to one of a first voltage source or a second voltage source; and a controller configured to control the switch matrix. The controller may be configured to, in each of a plurality of iterations: select a subset of one or more of the plurality of conductive strips; and control the switch matrix to connect the subset of conductive strips to the first voltage source, and connect all others of the plurality of conductive strips to the second voltage source. In each successive iteration, the subset of conductive strips that is selected may be adjacent, in a rotational direction around the longitudinal axis, to the subset of conductive strips that was selected in an immediately preceding iteration. The subset of conductive strips may comprise multiple ones of the plurality of conductive strips. In each successive iteration, the subset of conductive strips that is selected may overlap, by a number M of the plurality of conductive strips, with the subset of conductive strips that was selected in the immediately preceding iteration, and wherein M is greater than zero. For example, M may equal one. The subset of conductive strips may consist of multiple contiguous ones of the plurality of conductive strips. The subset of conductive strips that is selected may consist of one half of the plurality of conductive strips. The controller may be further configured to process amplitudes of signal strength for a satellite signal, received after control of the switch matrix, to acquire a position of a satellite. The plurality of iterations may be performed until the position of the satellite is acquired.

In an embodiment, a method of non-mechanical conical scanning, using a feed horn that comprises a conical section having a diameter that increases from a proximate end to a distal end along a longitudinal axis of the conical section, a plurality of conductive strips on a radially inner surface of the conical section, wherein each of the plurality of conductive strips extends from the proximate end to the distal end of the conical section, and a plurality of insulating gaps between each adjacent pair of the plurality of conductive strips, is disclosed. The method comprises, by a controller, in each of a plurality of rotational steps: selecting a subset of one or more of the plurality of conductive strips; and controlling a switch matrix to connect the subset of conductive strips to a first voltage source, and connect all others of the plurality of conductive strips to a second voltage source; wherein in each successive rotational step, the subset of conductive strips that is selected is adjacent, in a rotational direction around the longitudinal axis, to the subset of conductive strips that was selected in an immediately preceding rotational step. The subset of conductive strips may comprise multiple contiguous ones of the plurality of conductive strips. In each successive rotational step, the subset of conductive strips that is selected may overlap, by a number M of the plurality of conductive strips, with the subset of conductive strips that was selected in the immediately preceding rotational step, wherein M is greater than zero. The method may further comprise processing amplitudes of signal strength for a satellite signal, received after control of the switch matrix, to acquire a position of a satellite.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates conical scanning in the context of radar, according to an example;

FIG. 2 illustrates tracking of a satellite by a ground station, according to an embodiment;

FIG. 3 illustrates an antenna, according to an embodiment;

FIGS. 4A and 4B illustrate a perspective view and a cross-sectional side view, respectively, of an example feed horn, according to an embodiment;

FIGS. 5A and 5B illustrate the rotation of the offset center of an antenna beam, according to an embodiment;

FIG. 6 illustrates a process for controlling the feed horn of an antenna to acquire a target using non-mechanical conical scanning, according to an embodiment; and

FIG. 7 illustrates an example controller, by which one or more of the disclosed processes may be implemented, according to an embodiment.

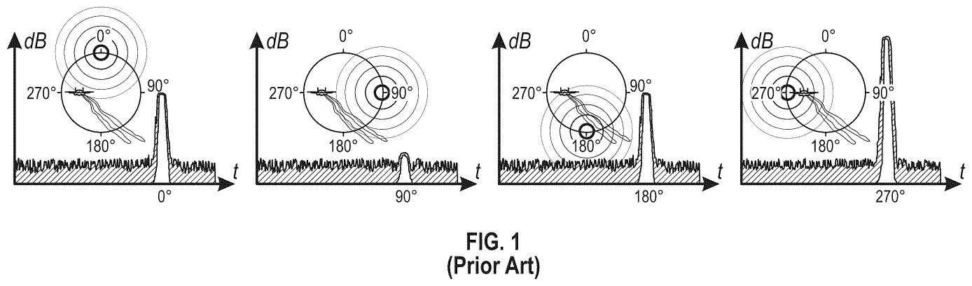

### DETAILED DESCRIPTION

Embodiments of non-mechanical conical scanning will now be described. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

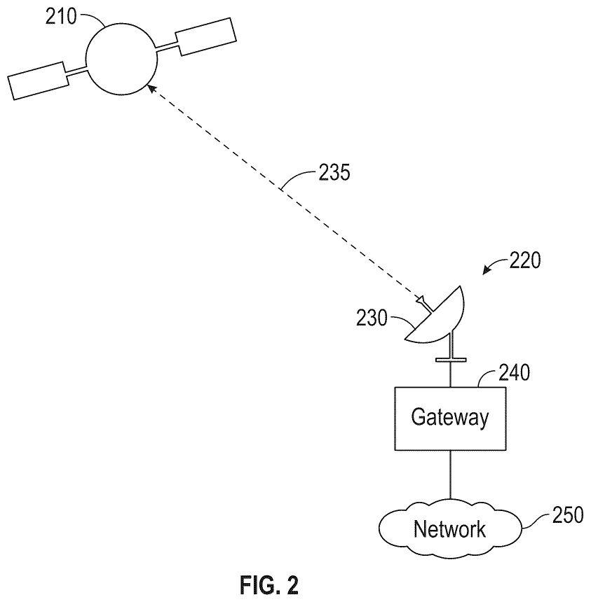

FIG. 2 illustrates tracking of a satellite 210 by a ground station 220, according to an embodiment. Satellite 210 orbits the Earth, for example, in low Earth orbit (LEO), which is typically defined as an altitude of between 160 kilometers and 2,000 kilometers above the Earth's surface. Satellites 210 in low Earth orbit tend to rapidly change position, over time, relative to ground station 220, which is located at a fixed position on the Earth's surface. Therefore, ground station 220 must constantly track the position of satellite 210.

Ground station 220 comprises an antenna 230 that tracks satellite 210 within its orbit. This tracking includes an initial acquisition of satellite 210. The goal of this initial acquisition and the subsequent tracking is to point antenna beam 235 of antenna 230 at satellite 210, to maximize signal strength, such that satellite 210 and ground station 220 may engage in effective communications via antenna 230.

Ground station 220 may comprise or communicate with a gateway 240 that provides communication between ground station 220 and a network 250. Thus, data may be received from satellite 210 by antenna 230 and forwarded through gateway 240 to a data destination on network 250. Additionally or alternatively, data may be received, through gateway 240, from a data source on network 250, and transmitted to satellite 210 by antenna 230. Ground station 220 may also comprise other equipment that provides supporting functions, such as signal processing, data processing, and/or the like.

While only a single satellite 210 and a single ground station 220 are illustrated, it should be understood that, in practice, the communications system may comprise any number of satellites 210 and ground stations 220. In this case, a single satellite 210 may communicate with a plurality of ground stations 220, and/or a single ground station 220 may track and communicate with a plurality of satellites 210.

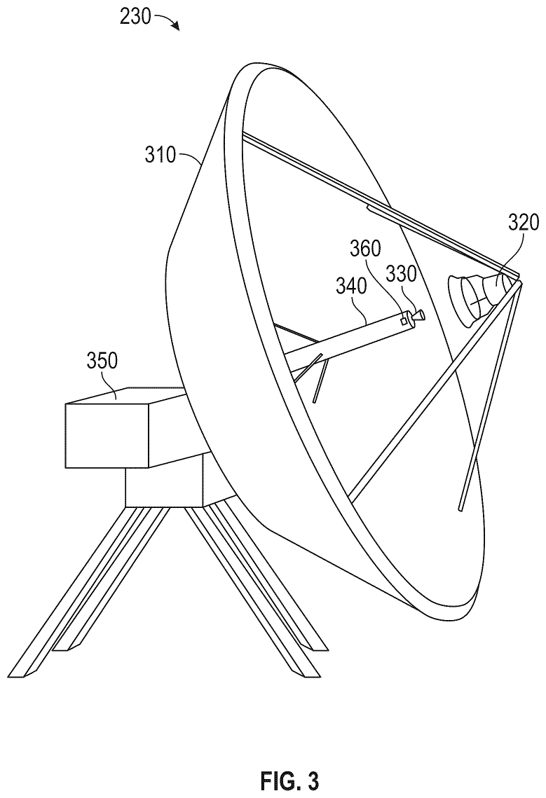

FIG. 3 illustrates an antenna 230, according to an embodiment. The illustrated antenna 230 is a dual-reflector Earth station antenna (ESA). Antenna 230 may comprise a parabolic reflector 310 and a sub-reflector 320. In addition, antenna 230 may comprise a feed horn 330, which may be fixed to reflector 310 or an alternative support structure via an outer support tube 340. Outer support tube 340 may enclose an RF network, including a switch matrix 360 that electrically connects feed horn 330 to the RF network under the control of a controller 350.

Controller 350 may comprise an input (i.e., transmit) port and/or output (i.e., receive) port. Controller 350 may control switch matrix 360, signal-processing equipment, data-processing equipment, and/or the like, to process signals received through the input port and transmit the processed signals through feed horn 330, and/or process signals received through feed horn 330 and output the processed signals through the output port.

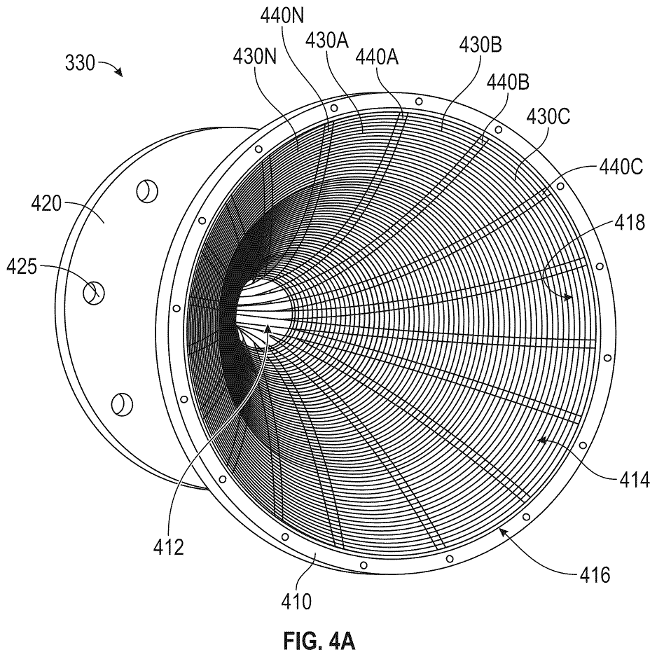

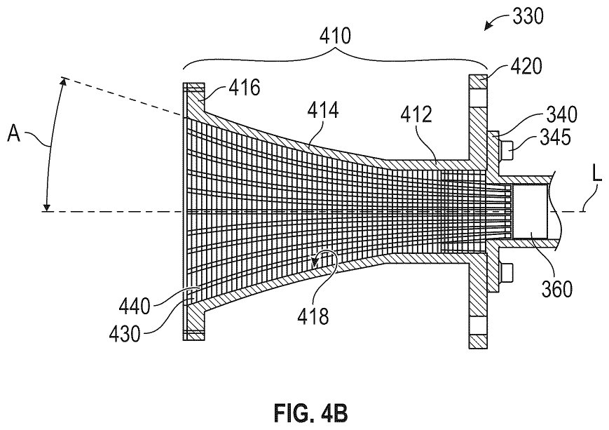

FIG. 4A illustrates a perspective view of a feed horn 330, and FIG. 4B illustrates a cross-sectional side view of feed horn 330, according to an embodiment. Feed horn 330 may comprise a horn 410 and a flange 420. Horn 410 and flange 420 may be manufactured as a single integral piece of material (e.g., via a molding or casting process, additive manufacturing, etc.) or may be manufactured as separate pieces of material (e.g., via molding or casting processes, additive manufacturing, etc.) that are subsequently joined via any suitable technique (e.g., welding, brazing, soldering, riveting, metal stitching, adhesion, etc.). In the latter case, horn 410 and flange 420 may be formed from the same type of material or different types of material. In an embodiment, the material of both horn 410 and flange 420 is metal, such as aluminum, brass, copper, stainless steel, or other good conductors that are resistant to environmental conditions.

As used herein, in the context of feed horn 330, the term “proximate” should be understood to mean closer or closest to the end of feed horn 330 that connects to outer support tube 340 (i.e., on which flange 420 is formed) and the term “distal” should be understood to mean farther or farthest from the end of feed horn 330 that connects to outer support tube 340 (i.e., opposite the proximate end), along a longitudinal axis L of feed horn 330. In addition, the terms “radial” and “radially” refer to an axis that is orthogonal to longitudinal axis L, and the terms “axial” or “axially” refer to an axis that is parallel to longitudinal axis L.

Horn 410 may comprise a cylindrical section 412, a conical section 414 that extends axially from the distal end of cylindrical section 412, and a flange 416 that extends radially outward from a distal end of conical section 414. Cylindrical section 412 may be substantially cylindrical with or without a constant diameter. Conical section 414 may have a diameter that increases from the proximate end to the distal end, along longitudinal axis L, at any suitable angle A with respect to longitudinal axis L, so as to form a conical shape. As an example, angle A may be equal fifteen degrees. Angle A, as well as the absolute and relative lengths of cylindrical section 412 and conical section 414, may depend on one or more applicable design factors, such as the frequency of operation and/or required gain. In an alternative embodiment of horn 410, cylindrical section 412 and/or flange 416 may be omitted.

Flange 420 may encircle and be fixed to the proximate end of cylindrical section 412 of horn 410. Flange 420 may comprise one or more apertures 425 that are each configured to receive a fastener 345 (e.g., screw, bolt, etc.) therethrough. Apertures 425 may be configured to align with apertures in a corresponding flange on the end of outer support tube 340, such that fasteners 345 may be inserted through and fixed within the aligned apertures, to fix flange 420, and thereby feed horn 330, to outer support tube 340.

Conical section 414 of horn 410 may be formed from corrugated metal with ridges and grooves, alternating axially along the radially inner surface 418 (i.e., facing longitudinal axis L) of horn 410. It should be understood that each ridge comprises an annular protrusion radially inward towards longitudinal axis L, and each groove comprises an annular recess radially outward away from longitudinal axis L. Each groove and ridge may be concentric around longitudinal axis L. The grooves may form one-quarter (¼th) waveguides, which provides better radiation-pattern performance for Gregorian and Cassegrain optics.

In an embodiment, a plurality of conductive strips 430 (e.g., illustrated as conductive strips 430A, 430B, 440C, . . . , 430N) are formed on radially inner surface 418 of horn 410. Each of the plurality of conductive strips 430 may extend axially along radially inner surface 418 from the proximate end to the distal end of conical section 414 of horn 410. In an embodiment, in which radially inner surface 418 comprises alternating ridges and grooves, each of the plurality of conductive strips 430 may follow the ridges and grooves, such that each conductive strip 430 comprises corresponding ridges and grooves.

In an embodiment, a plurality of insulating gaps 440 (e.g., illustrated as gap 440A, 440B, 440C, . . . , 440N) are formed, on radially inner surface 418 of horn 410, between each adjacent pair of the plurality of conductive strips 430, around longitudinal axis L. In other words, conductive strips 430 and insulating gaps 440 alternate circumferentially, along radially inner surface 418, around longitudinal axis L. Each insulating gap 440 may comprise insulation that prevents conductivity between adjacent conductive strips 430, or otherwise insulate adjacent conductive strips 430 from each other. For instance, insulating gap 440A insulates conductive strip 430A from conductive strip 430B, insulating gap 440B insulates conductive strip 430B from conductive strip 430C, and so on and so forth. It should be understood that, like each conductive strip 430, each of the plurality of insulating gaps 440 may extend axially along radially inner surface 418 from the proximate end to the distal end of conical section 414 of horn 410.

The number N of conductive strips 430 may be any integer greater than one (i.e., N>1). Thus, while eighteen conductive strips 430 are illustrated (i.e., N=18), horn 410 may comprise any other plural number of conductive strips 430, including less than eighteen but greater than one, or more than eighteen (e.g., at least eighteen), depending on one or more applicable design factors. In general, to implement conical scanning, the number of conductive strips 430 should be at least four (i.e., N≥4). It should be understood that the number of insulating gaps 440 will be equal to the number of conductive strips 430.

Each conductive strip 430 may comprise or consist of a material that enables the conductivity of conductive strip 430 to be controllable, for example, using bias voltage levels. On the proximate end, each of the plurality of conductive strips 430 may be conductively connected to switch matrix 360 within outer support tube 340, such that controller 350 may selectively and independently control the conductivity of each of the plurality of conductive strips 430 and/or groups of conductive strips 430. In particular, the proximate end of conductive strips 430 may be conductively connected to switch matrix 360, which is electrically coupled to one or more voltage sources. Switch matrix 360 may comprise a plurality of switches that open or close, under control of controller 350, to apply a bias voltage, from a voltage source, to each individual conductive strip 430 and/or groups of conductive strips 430.

The material of conductive strips 430 may be such that one or more properties of each conductive strip 430 changes depending on the voltage that is applied to that conductive strip 430. In this case, controller 350 may apply a low voltage or a high voltage to each conductive strip 430 to change a property, such as an electrical property, in the material of that conductive strip 430. These changeable properties may comprise at least electrical impedance. In other words, when the low voltage is applied to a conductive strip 430, the electrical impedance of the material in that conductive strip 430 has a first electrical impedance, and when the high voltage is applied to the conductive strip 430, the electrical impedance of the material in that conductive strip 430 has a second electrical impedance that is significantly different from the first electrical impedance.

In an embodiment, each conductive strip 430 comprises or consists of a semiconducting material, such as silicon, germanium, selenium, tellurium, or any suitable compound semiconductor, or a semi-metal. Preferably, the material of each conductive strip 430 has low impedance when a first voltage is applied to the conductive strip 430 and high impedance when a second voltage is applied to the conductive strip 430. In a particular embodiment, each conductive strip 430 comprises or consists of graphene or a similar material, which has low impedance when a high voltage is applied and a high impedance when a low voltage is applied. In a particular implementation using graphene, the surface impedance when the low voltage was applied was 450 Ohms per square, whereas the surface impedance when the high voltage was applied was 10 Ohms per square.

In the case of graphene, graphene flakes can be grown on a copper substrate or directly on radially inner surface 418 of conical section 414, for example, using chemical vapor deposition (CVD). These conductive strips 430 may be applied to or grown on radially inner surface 418 with insulating gaps 440 therebetween. While graphene may have an impact on the gain and/or loss of feed horn 330, this impact may be compensated or mitigated by increasing the size of feed horn 330.

In an embodiment, different voltages are applied to different ones of the plurality of conductive strips 430 in a rotational manner, by operation of switch matrix 360 under the control of controller 350. In other words, at a time of a first rotational step, a first voltage level (e.g., high or low bias voltage) is applied to a first subset of one or more conductive strips 430 (e.g., subset of adjacent conductive strips 430), while a second voltage level (e.g., low or high bias voltage) is applied to all of the other plurality of conductive strips 430, then at a time of a second rotational step, the first voltage level is applied to a second subset of one or more conductive strips 430 that is adjacent and subsequent to the first subset in a rotational direction around longitudinal axis L, while the second voltage level is applied to all of the other plurality of conductive strips 430, then at a time of a third rotational step, the first voltage level is applied to a third subset of one or more conductive strips 430 that is adjacent and subsequent to the second subset in the rotational direction, while the second voltage level is applied to all of the other plurality of conductive strips 430, and so on and so forth. Using an example in which each subset consists of a single conductive strip 430, in the first rotational step, the first voltage level is applied to conductive strip 430A while the second voltage level is applied to all of the other conductive strips 430 (i.e., 430B-430N), then in the second rotational step, the first voltage level is applied to conductive strip 430B while the second voltage level is applied to all of the other conductive strips 430 (i.e., 430A and 430C-430N), and so on and so forth. The direction of rotation may be in either direction (i.e., clockwise or counter-clockwise). The time interval between each rotation may be set to any suitable duration, as dictated by one or more design factors, including the speed at which the target (i.e., satellite 210) must be acquired or tracked.

In an embodiment, each subset of conductive strip(s) 430, selected for each rotational step, comprises a plurality of conductive strips 430. The number X of conductive strips 430 in each subset, selected in each rotational step, may be any integer greater than one. In a particular implementation, each subset of conductive strips 430, selected in each rotational step, consists of half of the total number N of conductive strips 430 (i.e., X=N/2, e.g., X=18/2=9 in the illustrated embodiment). The conductive strips 430 in each subset may be a contiguous set of conductive strips 430.

The subset of conductive strips 430 from one rotation to the successive rotational step may overlap by one or more conductive strips 430. For instance, in each rotational step, M (e.g., M=1) conductive strips 430 may be removed from the trailing side (i.e., opposite the direction of rotation) of the subset of conductive strips 430, while M (e.g., M=1) conductive strips 430 are added to the leading side (i.e., in the direction of rotation) of the subset of conductive strips 430. For example, the first subset of conductive strips 430 in an initial rotational step may consist of conductive strips 430A and 430B, the second subset of conductive strips 430 in the next rotational step may consist of conductive strips 430B and 430C (i.e., after conductive strip 430A was removed from the trailing side and conductive strip 430C was added to the leading side), and so on and so forth. Thus, it should be understood that, when a first subset of conductive strips 430 is described as being “adjacent” to a second subset of conductive strips 430, the two subsets may overlap by sharing X-M (e.g., where X=9 and M=1, X-M=9−1=8) conductive strips 430 on the leading side of the first subset and the trailing side of the second subset. In an alternative embodiment, the adjacent subsets of conductive strips 430, selected in each rotational step, do not overlap.

By applying different voltage levels to the plurality of conductive strips 430 in a rotational manner, the field across feed horn 330 is controlled to vary over time. This offsets the center of antenna beam 235 from the mechanical center (i.e., longitudinal axis L) of feed horn 330, and rotates the offset center of antenna beam 235 around the mechanical center of the overall reflector 310, to thereby implement conical scanning without having to mechanically rotate any of the components of antenna 230.

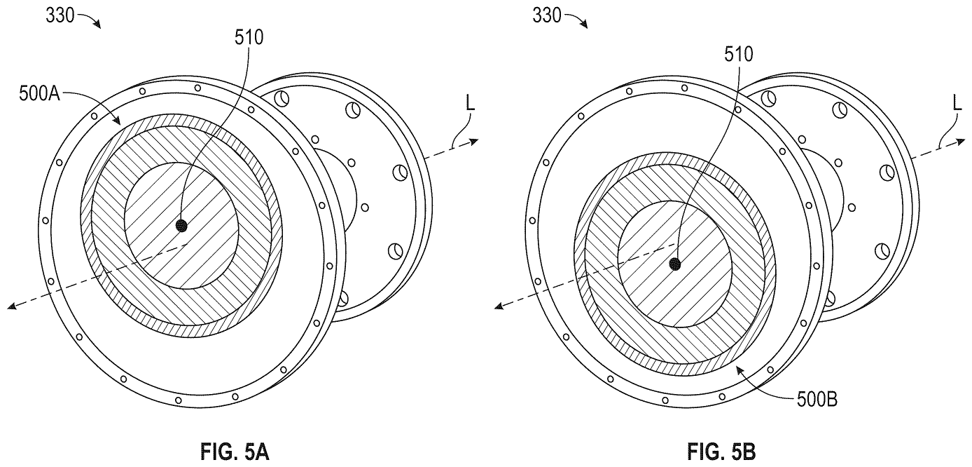

FIGS. 5A and 5B illustrate the rotation of the offset center 510 of antenna beam 235, according to an embodiment. The circles around offset center 510 of antenna beam 235 represent the field distribution of antenna beam 235. In FIG. 5A, switch matrix 360 is controlled, such that a subset of conductive strips 430 in region 500A of feed horn 330 have high impedance (e.g., via application of the low voltage), while the remaining conductive strips 430 have low impedance (e.g., via application of the high voltage). This moves center 510 of antenna beam 235 away from longitudinal axis L by an offset, towards region 500A. In FIG. 5B, switch matrix 360 is controlled, such that a different subset of conductive strips 430 in region 500B of feed horn 330 have low impedance, while the remaining conductive strips 430 have high impedance. This moves center 510 of antenna beam 235 away from longitudinal axis L by an offset, towards region 500B. As shown, by virtue of changing the conductive strip(s) 430 that have low or high impedance in a rotational manner around longitudinal axis L, the offset center 510 of antenna beam 235 can be rotated around longitudinal axis L.

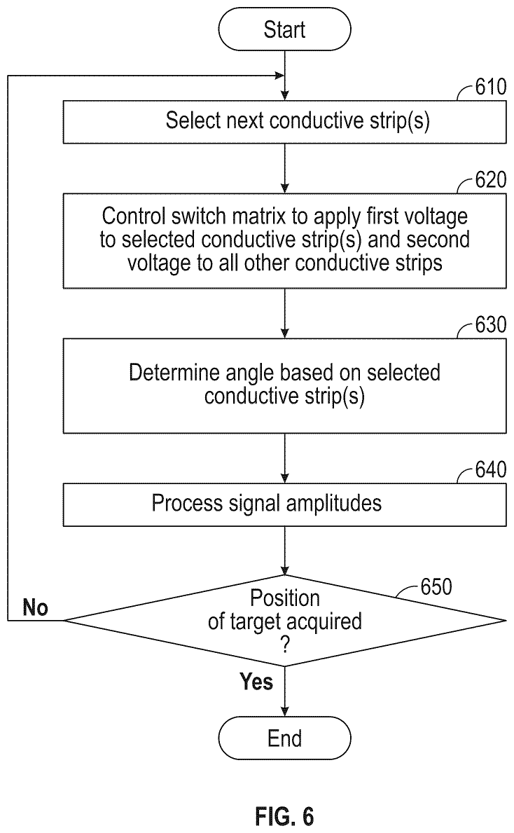

FIG. 6 illustrates a process 600 for controlling feed horn 330 of antenna 230 to acquire a target using non-mechanical conical scanning, according to an embodiment. While process 600 is illustrated with a certain arrangement and ordering of subprocesses, process 600 may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

Process 600 may be implemented by controller 350 in software and/or hardware. In particular, as discussed elsewhere herein, antenna 230 may comprise feed horn 330, switch matrix 360, comprising a plurality of switches configured to independently connect each of the plurality of conductive strips 430 in feed horn 330 to one of a first voltage source or a second voltage source, and controller 350. In this case, controller 350 may be configured to control switch matrix 360, according to process 600. Feed horn 330 may comprise at least a conical section 414 having a diameter that increases from a proximate end to a distal end along longitudinal axis L, a plurality of conductive strips 430 on radially inner surface 418 of conical section 414, and a plurality of insulating gaps 440 between each adjacent pair of the plurality of conductive strips 430. In addition, feed horn 430 may comprise a cylindrical section 412 extending along longitudinal axis L from the proximate end of conical section 414, and each of the plurality of conductive strips 430 may extend from the proximate end of cylindrical section 412 to the distal end of conical section 414.

In subprocess 610, a subset of one or more conductive strips 430 is selected. As discussed elsewhere, this subset may consist of one or a plurality of conductive strips 430. In an embodiment, the subset consists of multiple contiguous ones of the plurality of conductive strips 430. In a more particular embodiment, the subset of conductive strips 430 that is selected consists of one half of the plurality of conductive strips 430 (e.g., X=N/2).

In the initial iteration of subprocess 610, the subset of conductive strips 430 that is selected may be a predefined subset, may be a randomly selected subset, or may be determined in some other manner. In all subsequent iterations of subprocess 610, following this initial iteration, the subset of conductive strips 430 that is selected may be adjacent, in the rotational direction, to the preceding subset of conductive strips 430 that was selected in the most recent past iteration of subprocess 610. In other words, in each successive rotational step, the subset of conductive strips 430 that is selected in subprocess 610 is adjacent, in the rotational direction around longitudinal axis L, to the subset of conductive strips 430 that was selected in the immediately preceding rotational step.

In addition, as discussed elsewhere herein, each subset of conductive strips 430 may comprise multiple ones of the plurality of conductive strips 430. In this case, in each successive rotational step, the subset of conductive strips 430 that is selected in subprocess 610 may overlap, by a number M (e.g., M=1) of the plurality of conductive strips 430, with the subset of conductive strips 430 that was selected in the immediately preceding rotational step (i.e., in the most recent past iteration of subprocess 610). In this case, in each subsequent iteration of subprocess 610, M conductive strips 430 on the trailing side of the subset may be removed from the subset and an equal number of M conductive strips 430 ahead of the subset, relative to the rotational direction, may be added to the leading side of the subset.

In subprocess 620, switch matrix 360 is controlled to apply a first voltage to the subset of conductive strips 430, selected in the most recent iteration of subprocess 610, and a second voltage is applied to all of the other conductive strips 430 on radially inner surface 418 of horn 410 of feed horn 330. For example, switch matrix 360 may be controlled to connect the selected subset of conductive strips 430 to a first voltage source which applies a first bias voltage to the selected subset of conductive strips to thereby induce a low impedance in the selected subset of conductive strips 430, while connecting all of the remaining conductive strips 430 to a second voltage source which applies a second bias voltage to all of the remaining conductive strips 430 to thereby induce a high impedance in all of the remaining conductive strips 430.

In subprocess 630, the angle of antenna beam 235 is determined based on the selected subset of conductive strips 430. This angle may be the angle of center 510 of antenna beam 235 relative to the mechanical center, represented by longitudinal axis L. The angle may be determined based on which conductive strips 430 are in the selected subset and which conductive strips 430 are not in the selected subset. More particularly, in an embodiment in which impedance is the property that is changed in conductive strips 430, the angle of antenna beam 235 may be determined based on which conductive strips 430 currently have low impedance and which conductive strips 430 currently have high impedance.

In subprocess 640, the amplitudes of the signals that are received after the control in one or more of the most recent iterations of subprocess 620 may be processed to determine whether or not there is sufficient data to determine the position of the target (e.g., satellite 210). This signal processing may be performed in the same or similar manner as standard conical scanning which uses mechanical rotation. In particular, the highest amplitude in signal strength will occur when offset center 510 of antenna beam 235 points at the target. Thus, subprocess 640 may identify when the highest amplitude in signal strength is received, and correlate that peak amplitude with the angle and position of offset center 510 at the time that the peak amplitude was received.

In subprocess 650, it is determined whether or not the position of the target (e.g., satellite 210) has been acquired. It may be determined that the position of the target has been acquired when one or more criteria have been satisfied, and determined that the position of the target has not been acquired when the one or more criteria have not been satisfied. As an example, the one or more criteria may comprise the peak amplitude of the signal strength satisfying a threshold. When determining that the position of the target has been acquired (i.e., “Yes” in subprocess 650), process 600 may end. Otherwise, when determining that the position of the target has not been acquired (i.e., “No” in subprocess 650), process 600 may return to subprocess 610.

Although not shown, in an embodiment, process 600 could also comprise mechanically moving reflector 310 or other component of antenna 230, for example, when the target has been acquired (e.g., closed-loop or other control may be performed to finely point antenna beam 235 at the target), when the one or more criteria are not satisfied within a predefined amount of time, after a predefined number of iterations of subprocesses 610-650, and/or the like. Alternatively, process 600 could end, for example, when the one or more criteria are not satisfied within a predefined amount of time, after a predefined number of iterations of subprocesses 610-650, and/or the like. In this case, another process could be triggered to mechanically move reflector 310 and then restart process 600, and/or perform any other suitable fail-over function.

At a high level, process 600 executes a plurality of rotational steps, to rotate center 510 of antenna beam 235 around longitudinal axis L. In particular, in each of the plurality of rotational steps, a subset of one or more of the plurality of conductive strips 430 is selected, and switch matrix 360 is controlled to connect the subset of conductive strips 430 to a first voltage source (e.g., to induce low impedance in the selected subset of conductive strips 430), and connect all others of the plurality of conductive strips 430 to a second voltage source (e.g., to induce high impedance in the other conductive strips 430). During this rotation of center 510 of antenna beam 235 around longitudinal axis L, the amplitudes of signal strength, for a satellite signal received from satellite 210, after each control of switch matrix 360, may be processed to acquire a position of satellite 210. This plurality of rotational steps may be performed until the position of satellite 210 is acquired.

Disclosed embodiments represent an improvement to the antenna-beam-pointing methods of conical scanning. In particular, disclosed embodiments are capable of non-mechanical conical scanning with a very high scan frequency, limited only by the processing power of the receiver/tracking system. Consequently, disclosed embodiments are beneficial for acquiring and tracking targets that are moving relatively fast. In addition, since the rotation of antenna beam 235 is digitally controllable, variable scan frequencies are possible. The lack of mechanical motion also increases the overall life span of antenna 230. Furthermore, disclosed embodiments only require a simple change to the structure of feed horn 330 and switch matrix 360.

While embodiments are described herein as rotating center 510 of antenna beam 235, additional or alternative field patterns could be implemented. In particular, the subset of conductive strips 430 that are selected in subprocess 610 of process 600 may be selected in some pattern other than in a rotational pattern. For instance, subsets of conductive strips 430, in successive iterations of subprocess 610, may be selected according to a raster-scan pattern, spiral-scan pattern, or the like. Advantageously, changes to the pattern may be performed electronically, via controller 350, without any mechanical change to feed horn 330, by simply programming controller 350 to select subsets of conductive strips 430 according to a new algorithm implementing the new pattern.

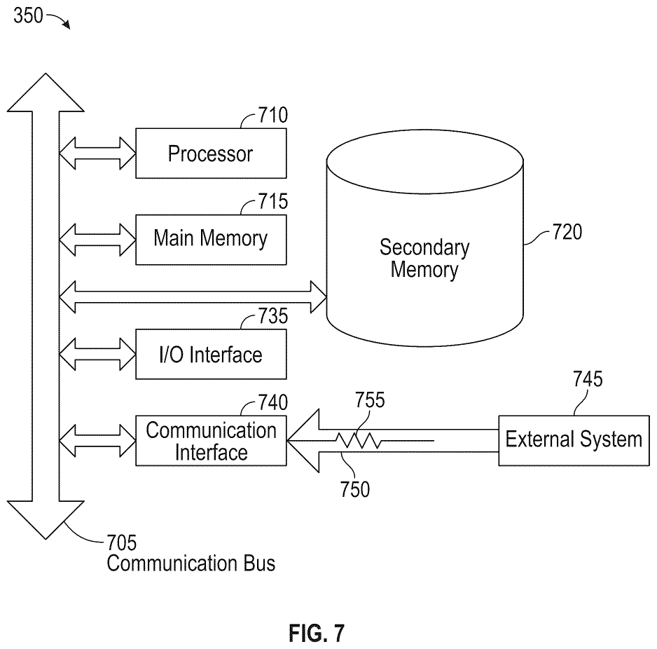

FIG. 7 illustrates an example controller 350, by which one or more of the disclosed processes may be implemented, according to an embodiment. For example, controller 350 may store and execute software that implements process 600. Controller 350 can be any processor-enabled device that is capable of wired or wireless data communication. Other architectures may also be used, and one or more components may be added to or omitted from the illustrated architecture, as will be clear to those skilled in the art.

Controller 350 may comprise one or more processors 710. Processor(s) 710 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 710. Examples of processors which may be used in controller 350 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor(s) 710 may be connected to a communication bus 705. Communication bus 705 may include a data channel for facilitating information transfer between storage and other peripheral components of controller 350. Furthermore, communication bus 705 may provide a set of signals used for communication with processor 710, including a data bus, address bus, and/or control bus (not shown). Communication bus 705 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

Controller 350 may comprise main memory 715. Main memory 715 provides storage of instructions and data for programs executing on processor 710, such as any of the software discussed herein, including software implementing process 600. It should be understood that programs stored in the memory and executed by processor 710 may be written and/or compiled according to any suitable language, including without limitation C/C++, Java, JavaScript, Perl, Python, Visual Basic, .NET, and the like. Main memory 715 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Controller 350 may comprise secondary memory 720. Secondary memory 720 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within controller 350. The computer software stored on secondary memory 720 is read into main memory 715 for execution by processor 710. Secondary memory 720 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Controller 350 may comprise an input/output (I/O) interface 735. I/O interface 735 provides an interface between one or more components of controller 350 and one or more input and/or output devices. For example, I/O interface 735 may provide communication between controller 350 and switch matrix 360, such that controller 350 can control switches within switch matrix 360, acquire the status of one or more switches in switch matrix 360, and/or the like. I/O interface 735 may also provide communication between controller 350 and an input and/or output port of antenna 230.

Controller 350 may comprise a communication interface 740. Communication interface 740 allows software to be transferred between controller 350 and external devices, networks, or other information sources, such as gateway 240. For example, data may be transferred to controller 350 from gateway 240 or transferred to gateway 240 from controller 350, via communication interface 740. Examples of communication interface 740 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing controller 350 with a network (e.g., gateway 240) or another computing device. Communication interface 740 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 740 is generally in the form of electrical communication signals 755. These signals 755 may be provided to communication interface 740 via a communication channel 750 between communication interface 740 and an external system 745 (e.g., gateway 240). In an embodiment, communication channel 750 may be a wired or wireless network, or any variety of other communication links. Communication channel 750 carries signals 755 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 715 and/or secondary memory 720. Computer-executable code can also be received from an external system 745 via communication interface 740 and stored in main memory 715 and/or secondary memory 720. Such computer-executable code, when executed by processor(s) 710, may enable controller 350 to perform the various functions of the disclosed embodiments as described elsewhere herein, including, for example, process 600.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A feed horn for an antenna, the feed horn comprising:
a conical section having a diameter that increases from a proximate end to a distal end along a longitudinal axis of the conical section;
a plurality of conductive strips on a radially inner surface of the conical section, wherein each of the plurality of conductive strips extends from the proximate end to the distal end of the conical section; and
a plurality of insulating gaps between each adjacent pair of the plurality of conductive strips.

2. The feed horn of claim 1, wherein each of the plurality of conductive strips is formed from a material that has low impedance when a first voltage is applied to the conductive strip and has high impedance when a second voltage is applied to the conductive strip.

3. The feed horn of claim 1, wherein each of the plurality of conductive strips comprises a semiconducting or semi-metal material.

4. The feed horn of claim 1, wherein each of the plurality of conductive strips comprises graphene.

5. The feed horn of claim 1, wherein a number of the plurality of conductive strips is at least four.

6. The feed horn of claim 1, further comprising a cylindrical section extending along the longitudinal axis from the proximate end of the conical section, wherein each of the plurality of conductive strips extends from a proximate end of the cylindrical section to the distal end of the conical section.

7. An antenna comprising:
the feed horn of claim 1;
a switch matrix that comprises a plurality of switches configured to independently connect each of the plurality of conductive strips in the feed horn to one of a first voltage source or a second voltage source; and
a controller configured to control the switch matrix.

8. The antenna of claim 7, wherein the controller is configured to, in each of a plurality of iterations:
select a subset of one or more of the plurality of conductive strips; and
control the switch matrix to connect the subset of conductive strips to the first voltage source, and connect all others of the plurality of conductive strips to the second voltage source.

9. The antenna of claim 8, wherein in each successive iteration, the subset of conductive strips that is selected is adjacent, in a rotational direction around the longitudinal axis, to the subset of conductive strips that was selected in an immediately preceding iteration.

10. The antenna of claim 8, wherein the subset of conductive strips comprises multiple ones of the plurality of conductive strips.

11. The antenna of claim 10, wherein in each successive iteration, the subset of conductive strips that is selected overlaps, by a number M of the plurality of conductive strips, with the subset of conductive strips that was selected in the immediately preceding iteration, and wherein M is greater than zero.

12. The antenna of claim 11, wherein M equals one.

13. The antenna of claim 10, wherein the subset of conductive strips consists of multiple contiguous ones of the plurality of conductive strips.

14. The antenna of claim 13, wherein the subset of conductive strips that is selected consists of one half of the plurality of conductive strips.

15. The antenna of claim 8, wherein the controller is further configured to process amplitudes of signal strength for a satellite signal, received after control of the switch matrix, to acquire a position of a satellite.

16. The antenna of claim 15, wherein the plurality of iterations are performed until the position of the satellite is acquired.

17. A method of non-mechanical conical scanning, using a feed horn that comprises a conical section having a diameter that increases from a proximate end to a distal end along a longitudinal axis of the conical section, a plurality of conductive strips on a radially inner surface of the conical section, wherein each of the plurality of conductive strips extends from the proximate end to the distal end of the conical section, and a plurality of insulating gaps between each adjacent pair of the plurality of conductive strips, the method comprising, by a controller, in each of a plurality of rotational steps:
selecting a subset of one or more of the plurality of conductive strips; and
controlling a switch matrix to connect the subset of conductive strips to a first voltage source, and connect all others of the plurality of conductive strips to a second voltage source;
wherein in each successive rotational step, the subset of conductive strips that is selected is adjacent, in a rotational direction around the longitudinal axis, to the subset of conductive strips that was selected in an immediately preceding rotational step.

18. The method of claim 17, wherein the subset of conductive strips comprises multiple contiguous ones of the plurality of conductive strips.

19. The method of claim 18, wherein in each successive rotational step, the subset of conductive strips that is selected overlaps, by a number M of the plurality of conductive strips, with the subset of conductive strips that was selected in the immediately preceding rotational step, and wherein M is greater than zero.

20. The method of claim 17, further comprising processing amplitudes of signal strength for a satellite signal, received after control of the switch matrix, to acquire a position of a satellite.
